(19) United States
(12) Patent Application Publication
(10) Pub. No.: US 2016/0227735 A1
(43) Pub. Date: Aug. 11, 2016

(54) BOWL FOR FEEDING PETS

(71) Applicant: MARS, INCORPORATED, McLean, VA (US)

(72) Inventor: Andrea Withopf, Kirchlinteln (DE)

(73) Assignee: Mars, Incorporated, McLean, VA (US)

(21) Appl. No.: 15/022,823

(22) PCT Filed: Sep. 3, 2014
(86) PCT No.: PCT/EP2014/068706

§ 371 Date: Mar. 17, 2016

(30) Foreign Application Priority Data
Sep. 17, 2013 (DE) 102013015350.6

(51) Int. Cl. A01K 5/01; A01K 15/02

(52) U.S. Cl. CPC A01K 5/0114; A01K 15/02

(57) ABSTRACT

The present invention relates to a bowl comprising a) a bowl main body (1) with a rocking member (3) joined to the bottom thereof, and b) a releasable transparent lid (2) joined to the upper side of the bowl main body (1) and having at least one opening.

The present invention relates to a bowl for feeding pets.

Pets have to be fed. This is normally done by placing a measured quantity of food in a bowl standing more or less fixed in place, which the pet then eats. With this kind of feeding, it can easily happen that too much food is taken, so that the pet becomes overweight and has too little exercise. In addition, many pets eat too quickly, which can cause vomiting.

Also, many pets are not given sufficient mental challenges.

US2012/0298044 A1 discloses a feeding toy for pets which is constructed from two hemi-spheres, wherein feeding apertures are provided in a lower hemisphere, via which pieces of food are dispensed by means of a defined dispensing mechanism, which has to be triggered by the pet. In that feeding toy, the feeding apertures do not permit the pet access to the interior of the hemispheres; instead, when the dispensing mechanism is actuated, the food falls out of the feeding apertures. In addition, the food inside the feeding toy cannot be detected visually by a pet.

2010/0095902 A1 describes a pet toy that is constructed from a flexible and axially flat body with a hollow formed therein. Pet food can be placed in that hollow, where the pet can retrieve it via a narrow opening. In that pet toy too, the interior is not accessible to the pet; when the toy is held in the right position, the food falls out of the narrow opening. In addition, the pet food inside this pet toy can only inadequately be detected visually by the pet.

It is an object of the present invention to provide a bowl for feeding pets with which feeding can be controlled better, especially extended over a longer time, and at the same time the pet is presented with a mental challenge to retrieve the pet food from that bowl.

This object is achieved by a bowl comprising:
a) a bowl main body with a rocking member joined to the bottom thereof, and
b) a releasable transparent lid joined to the upper side of the bowl main body and having at least one opening.

It is particularly preferable in this connection that the bowl main body and/or the lid should be made of plastic, preferably thermoplastic plastic.

It is also preferably contemplated that the rocking member is releasable from the bowl main body.

In a preferred embodiment, it is contemplated that the rocking member is made of plastic, preferably thermoplastic plastic, and is weighed down with a weight.

It is further preferably contemplated that the rocking member is substantially hemispherical in shape.

In a preferred embodiment, it is contemplated that the lid has one, two or three openings.

It is also preferably envisaged that at least one opening permits access to the bowl for a paw of a pet, preferably a cat's.

One embodiment is characterised by the fact that the lid and/or the rocking member can be screwed together with the bowl main body by means of a thread or connected to it by means of a snap connection.

It is also preferable that the lid has a flat or hood-like upper surface and a side rim running round the upper surface and extending substantially downwards.

Finally, it may be contemplated in accordance with the invention that the at least one opening extends above the upper surface and the side rim of the lid.

It has surprisingly been found that with the bowl in accordance with the invention, which is filled with pet food, a pet's feeding can be controlled and in particular extended, and at the same time the pet is presented with a mental challenge to retrieve the pet food from that bowl.

For the pet, the pet food contained in the bowl is visible through the transparent lid, but it is not easy to remove from the bowl. Rather, the pet has to realise that one or more openings are provided in the transparent lid, which are preferably of a size that at least one of the openings allows access for a pet's paw. In order to gain access to the interior of the bowl, the pet therefore has to find out that the interior of the bowl is accessible for a paw and, if successful, can remove pet food from that bowl. It is made more difficult to remove by the fact that the bowl of the invention rocks or wobbles. This is achieved by the rocking member provided on the bottom of the bowl main body. That rocking member is preferably hemispherical in shape and is preferably weighed down with a weight, so that the bowl is always maintained in an upright position when not subjected to an intervention by the pet. Depending on the desired amount of rocking, which can preferably be adjusted to suit the size of the pet, the rocking member can be selected by joining on a suitable rocking member with a flatter or deeper shape.

In a particularly preferred embodiment, the lid has a substantially flat or hood-like upper surface, from which a peripheral side rim extends downwards. In this embodiment, it is then preferable that the at least one opening extends above part of the upper surface and part of the peripheral side rim. This ensures that the pet can introduce its paw relatively into the interior of the bowl easily and without major contortions and, after grabbing the piece of food, can withdraw its paw, together with the piece of food, from the bowl with no difficulty.

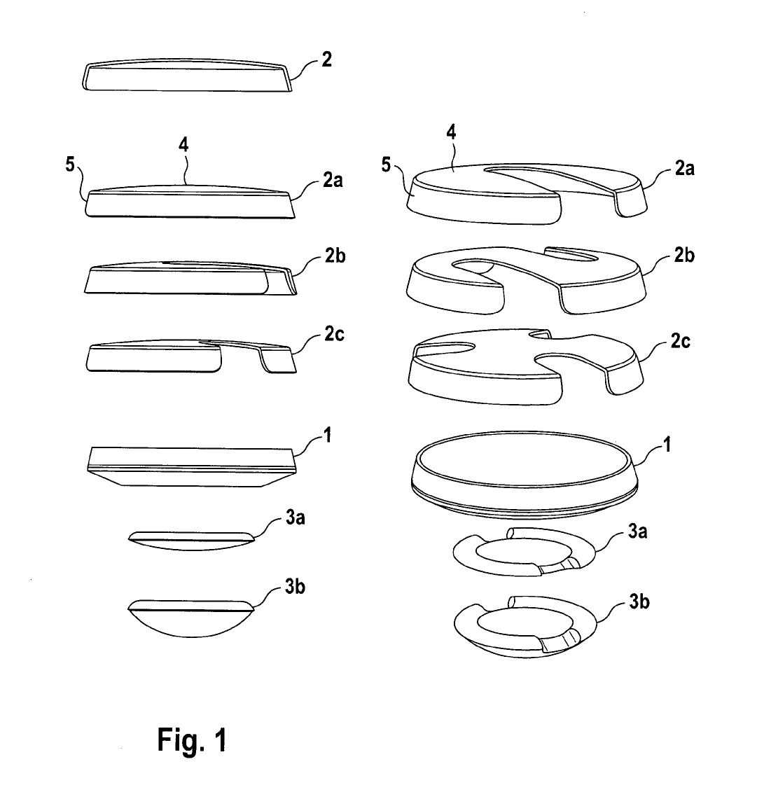

Further features and advantages of the bowl of the invention will become clear from the following detailed description of a worked embodiment with reference to the attached drawing, in which FIG. 1 shows components of the bowl in a perspective and exploded side view.

In FIG. 1 the reference numeral 1 designates a bowl main body. The shape of the bowl main body 1 does not have to satisfy any particular requirements, except of course that it has to be possible for pet food to be placed in the interior of the bowl main body 1. The bowl main body 1 can likewise be transparent.

The bowl main body 1 can be closed with a lid 2. In FIG. 1, three embodiments of the lid 2a, 2b, 2e are shown, with one opening, two openings and three openings respectively. The lid 2 is preferably configured with an upper surface and a peripheral side wall 5 extending downwards, wherein at least one of the openings extends both over the upper surface 4 and over the peripheral side wall 5. This shape of the opening makes it easier for the pet, having introduced a paw into the bowl, to remove pet food from the bowl.

Finally, the bowl of the invention comprises a rocking member 3, two embodiments of which are likewise shown in FIG. 1. A first embodiment in the form of a shallow rocking member 3a provides a limited rocking and wobbling movement, and an embodiment 3b with a deeper rocking member enables more pronounced rocking.

The bowl main body 1, the lid 2 and the rocking member 3 can be fitted together in a way that is known per se in the art. They could, for example, be screwed together using the thread provided, or the components could be joined together by means of a snap connection.

The features of the invention disclosed in the above description, the claims and the drawings can be essential to implementing the invention in its various embodiments both individually and in any combination at all.

1. A bowl comprising:
a) a bowl main body with a rocking member joined to the bottom thereof, and
b) a releasable transparent lid, joined to the upper side of the bowl main body and having at least one opening.

2. The bowl of claim 1, wherein the bowl main body and/or the lid is/are made of plastic.

3. The bowl of claim 1, wherein the rocking member is releasable from the bowl main body.

4. The bowl of claim 1, wherein the rocking member is made of plastic, preferably thermoplastic plastic, and is weighed down with a weight.

5. The bowl of claim 1, wherein the rocking member is substantially hemispherical in shape.

6. The bowl of claim 1, wherein the lid has one, two or three openings.

7. The bowl of claim 1, wherein at least one opening permits access to the bowl for a paw of a pet, preferably a cat's.

8. The bowl of claim 1, wherein the lid and/or the rocking member can be screwed together with the bowl main body by means of a thread or connected to it by means of a snap connection.

9. The bowl of claim 1, wherein the lid has a flat or hood-like upper surface and a side rim running peripherally round the upper surface and extending substantially downwards.

10. The bowl of claim 9, wherein the at least one opening extends above the upper surface and the side rim of the lid.
